(19) United States
(12) Patent Application Publication
(10) Pub. No.: US 2007/0045385 A1
(43) Pub. Date: Mar. 1, 2007

(54) Jointed assembly, assembling method thereof, assembling jig, and powder treating device

(75) Inventor: Takeshi Okoshi, Saitama (JP)

Correspondence Address: SUGHRUE-265550, 2100 PENNSYLVANIA AVE. NW, WASHINGTON, DC, 20037-3213, US

(73) Assignee: FUJI XEROX CO., LTD.

(21) Appl. No.: 11/333,331

(22) Filed: Jan. 18, 2006

(30) Foreign Application Priority Data
Aug. 25, 2005 (JP) P2005-244008

(51) Int. Cl. B23K 20/10

(52) U.S. Cl. 228/110.1

(57) ABSTRACT

A jointed assembly includes a first joining member having a face to be welded at at least an end face thereof and a second joining member having a joint receiving part to which the end face of the first joining member is joined. One of the first and second joining members includes on an outer face thereof an engaged part with which a receiving jig is engaged when the first and second joining members are welded to each other by a heat welding process. The other of the first and second joining members includes on an outer face thereof an abutting part against which a welding jig abuts. A welded part at which the first and second joining members are welded is interposed between the abutting part and the engaged part.

### BACKGROUND OF THE INVENTION

1. Field of the Invention

The present invention relates to an improvement of a jointed assembly which is applied to a powder container employed in a powder treating device such as a toner cartridge in which toner to be used in an image forming apparatus such as a copying machine, a printer, etc. is contained, a method of assembling the same, and an assembling jig.

2. Description of the Related Art

Heretofore, in case of producing, by ultrasonic welding process or the like, a toner storage container such as a toner cartridge which is used in an image forming apparatus of, for example, electro-photographic system or the like, there has been such a method that parts to be welded of both a joining member and a joined member are overlapped, and a receiving jig abuts against the overlapped parts from below, while a welding horn abuts from above so as to clamp the overlapped parts therebetween, whereby welding by ultrasonic waves is performed (See JP-A-2003-248370, for example).

FIG. 16 shows the toner storage container which is disclosed in JP-A-2003-248370, and there is described a system for welding a developing frame 211 at a developing side to a frame 201 of the container in which the toner is contained. On this occasion, welded parts 202 and 203 of the container frame 201 and welded parts 212 and 213 of the developing frame 211 are engaged with each other, and two receiving jigs 231 and 232 for receiving the container frame 201 are fitted to lower faces of the welded parts 202 and 203 of the container frame 201. On the other hand, two welding horns 221 and 222 abut against surfaces of the welded parts 212 and 213 of the developing frame 211.

Therefore, the welding horns 221 and 222 and the receiving jigs 231 and 232 will press each other in a vertical direction, whereby the ultrasonic welding will be performed in the welded parts.

### SUMMARY OF THE INVENTION

However, in this system, the welding horn and the receiving jig are so arranged as to push each other in the vertical direction, interposing the welded part between a joining member and a joined member (respectively corresponding to the container frame and the developing frame) therebetween. For this reason, welding margins (corresponding to the welded parts) will protrude from outer peripheries of the container frame and the developing frame, after welding, thereby to form so-called flanges (This welding process corresponds to so-called direct welding).

Therefore, there have been such problems that it is difficult to downsize the toner storage container, even though this is intended, and that layout of other functional components cannot be freely done, because the above described flanges might be obstacles.

On the other hand, in order to eliminate such flanges, the welding horn may be separated from the receiving jig. For example, after the container frame has been set on the receiving jig, the container frame and the developing frame maybe engaged with each other, so that welding may be conducted from a bottom face of the container frame and from an upper face of the developing frame (Such welding process corresponds to so-called transmitting welding). However, in this welding process, effective transmission of energy to the welded parts cannot be performed. Consequently, joint strength will be lowered and the frames will be deformed, which will make it difficult to obtain stabilized joint.

The invention has been made in view of above circumstances and provides a jointed assembly an assembling method thereof, assembling jig, and a powder treating device. An embodiment of the present invention addresses a jointed assembly for enabling a joining member and a joined member to be stably joined to each other, without providing flanges, a powder treating device provided with a powder container which has been joined by this jointed assembly, a method of assembling the jointed assembly, and an assembling jig.

According to a first aspect of the present invention, there is provided a jointed assembly including: a first joining member having a face to be welded at at least an end face thereof; and a second joining member having a joint receiving part to which the end face of the first joining member is joined; wherein one of the first and second joining members includes on an outer face thereof an engaged part with which a receiving jig is engaged when the first and second joining members are welded to each other by a heat welding process; wherein the other of the first and second joining members includes on an outer face thereof an abutting part against which a welding jig abuts; and wherein a welded part at which the first and second joining member are welded is interposed between the abutting part and the engaged part.

According to a second aspect of the present invention, there is provided the jointed assembly according to the first aspect, wherein the engaged part is provided with the one of the first or the second joining members in vicinity of the welded part; and wherein the engaged part is formed with a recess which is dented from the outer face of the one of the first and second joining members.

According to a third aspect of the present invention, there is provided the jointed assembly according to the second aspect, wherein the engaged part includes a guide projection that guides the receiving jig into the recess in a part of a surrounding edge of the recess.

According to a fourth aspect of the present invention, there is provided the jointed assembly according to the first aspect, wherein the end face of the first joining member and the joint receiving part of the second joining member include inclined faces respectively in at least a part thereof.

According to a fifth aspect of the present invention, there is provided a powder treating device including a powder container including the jointed assembly according to the first aspect.

According to a sixth aspect of the present invention, there is provided the powder treating device according to the fifth aspect, wherein the powder includes a developing powder.

According to a seventh aspect of the present invention, there is provided an assembling method for assembling a jointed assembly according to the first aspect including: fitting the receiving jig in the engaged part which is provided in the one of the first and second joining members; and joining the first and second joining members; wherein, in the joining, the welding jig abuts against the abutting part of the other of the first and second joining members.

According to a eighth aspect of the present invention there is provided the assembling method for the jointed assembly according to the seventh aspect, wherein the receiving jig and the welding jig press each other in directions intersecting at a substantially right angle.

According to a ninth aspect of the present invention there is provided an assembling jig for assembling the jointed assembly according to the first aspect. The jig includes: the receiving jig which is fitted into the engaged part in the one of the first and second members; and the welding jig which is pressed onto the outer face of the other of the first and second joining member; wherein the receiving jig includes a projected portion to be fitted into the engaged part.

### BRIEF DESCRIPTION OF THE DRAWINGS

Embodiments of the present invention will be described in detail based on the following figures, wherein:

FIGS. 1A and 1B are explanatory views for schematically showing a welding system according to an embodiment of the invention;

FIG. 2 is an explanatory view showing an image forming apparatus in which an embodiment 1 of the welding system according to an embodiment of the invention is employed;

FIGS. 3 show particulars of a process cartridge employed in the embodiment 1, in which FIG. 3A is a perspective view as seen from one side, and FIG. 3B is a perspective view as seen from an opposite side;

FIG. 4 is a perspective view of the process cartridge in the embodiment 1, as seen from still another side;

FIG. 5 is an enlarged perspective view, partly in section, of an essential part of FIG. 4;

FIG. 6 is an explanatory view showing welding process in the embodiment 1;

FIG. 7 is a perspective view of the process cartridge in the embodiment 1 in a state where a surface cover has been removed;

FIG. 8 is an explanatory view showing the welding process in the embodiment 1 in another part;

FIG. 9 is an enlarged view of an essential part of FIG. 8;

FIG. 10 is an explanatory view showing an entirety of FIG. 8;

FIG. 11 is an explanatory view showing the welding process as a variation 1 of the embodiment 1;

FIG. 12 is an explanatory view showing the welding process as a variation 2 of the embodiment 1;

FIG. 13 is an explanatory view showing welding system according to an embodiment 2;

FIG. 14 is an enlarged sectional view of the embodiment 2;

FIGS. 15A and 15B are explanatory views showing variations of the embodiment 2;

FIG. 16 is an explanatory view schematically showing a conventional welding system.

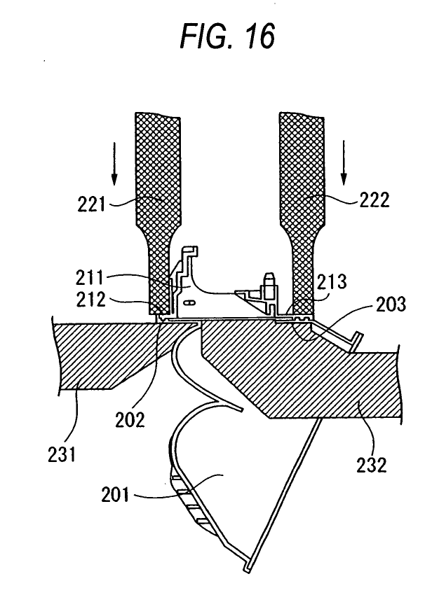

### DETAILED DESCRIPTION OF THE INVENTION

Now, the present invention will be described in detail, referring to the attached drawings showing an embodiment of the invention.

### Embodiment 1

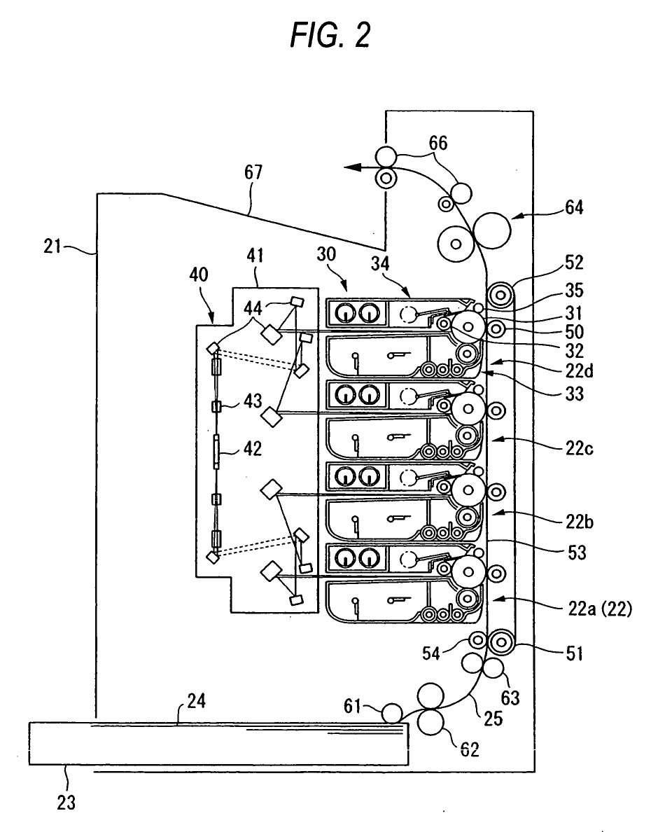

FIG. 2 shows an image forming apparatus in which a process cartridge to which the invention is applied is installed.

In FIG. 2, the image forming apparatus in this embodiment is a so-called tandem type color image forming apparatus. In a casing 21 of the apparatus, image forming units 22 (22a to 22d) of four colors (yellow, magenta, cyan, black, in this embodiment) are arranged in a vertical direction, and a paper feeding cassette 23 containing sheets of paper 24 to be fed is disposed below the image forming units 22. Moreover, a paper conveying passage 25, which is a conveying passage of the sheets of paper 24 from the paper feeding cassette 23, is arranged in a vertical direction so as to pass those positions corresponding to the image forming units 22.

In this embodiment, the image forming units 22 (22a to 22d) form toner images for yellow, magenta, cyan and black in order from an upstream side of the paper conveying passage 25, and are provided with process cartridges 30 in which various process units are incorporated, and an exposing device 40 which irradiates scanning light for image forming to these process cartridges 30. In this embodiment, the process cartridge 30 includes a photoconductor drum 31, an electrifying roll 32 for electrifying this photoconductor drum 31 in advance, a developing device 33 for developing an electrostatic latent image which has been formed on the electrified photoconductor drum 31 by the exposing device 40 with toner of the corresponding color (for example, negatively charged toner, in this embodiment), and a cleaning device 34 for removing waste toner on the photoconductor drum 31, and an erase lamp 35 for diselectrifying a surface of the electrified photoconductor drum 31, all of which are contained in an integral cartridge.

On the other hand, the exposing device 40 includes a semiconductor laser (not shown), a polygon mirror 42, an image forming mirror 43, and a mirror 44 contained in a case 41, and is adapted to guide a laser light from the semiconductor laser to an exposing point on the photoconductor drum 31 by way of the polygon mirror 32, the image forming mirror 43, and the mirror 44.

In this embodiment, there is further provided, at the positions corresponding to the photoconductor drums 31 of the respective image forming units 22, a conveying belt 53 which circularly moves along the paper conveying passage 25.

This conveying belt 53 is formed of belt material (rubber or resin) capable of electrostatically sucking the sheets of paper 24, and stretched between a pair of stretching rolls 51 and 52. In this embodiment, the stretching roll 52 at an upper side is a driving roll, and the stretching roll 51 at a lower side is a driven roll.

Still further, a paper suction roll 54 is provided at a position corresponding to an inlet of the conveying belt 53 (a position opposed to the stretching roll 51), and high voltage electric pressure for suction is applied to the paper suction roll, thereby to suck the sheet of paper 24 to the conveying belt 53. Furthermore, transfer rolls 50 are provided at a back face side of the conveying belt 53, at the positions corresponding to the photoconductor drums 31 of the respective image forming units 22, and the photoconductor drums 31 are so adapted to be brought into tight contact with the sheet of paper 24 on the conveying belt 53, by means of the transfer rolls 50. A determined transfer bias is adapted to be appropriately applied between the transfer roll 50 and the photoconductor drum 21, from a transfer bias source which is not shown.

Moreover, in this embodiment, a pickup roll 61 for feeding out the sheet of paper 24 at a determined timing is provided near the paper feeding cassette 23. The pickup roll 61 is adapted to feed the sheet 24 to a transfer position by way of a conveying roll 62 and a registration roll 63 which performs positioning control of the sheet 24.

Still further, a fixing device 64 composed of a heating roll and a pressing roll, for example, is provided on the paper conveying passage 25, downstream from the most downstream image forming unit 22d, and a discharging roll 66 for paper discharge is provided downstream from this fixing device 64, so that the sheet of paper to be discharged may be contained in a containing tray 67 which is formed in an upper part of the casing 21 of the apparatus.

In the image forming apparatus having the above described structure, process for forming an image is as follows.

In the respective image forming units 22, as shown in FIG. 2, the photoconductor drum 31 is electrified by the electrifying roll 32, and a latent image is formed on the photo conductor drum 31 by the exposing device 40. Thereafter, a visual image (a toner image) will be formed by the developing device 33.

On the other hand, the sheet of paper 24 will be paid out at a determined timing, from the paper feeding cassette 23 by means of the pickup roll 61, to be fed to the sucking position of the conveying belt 53 by means of the conveying roll 62 and the registration roll 63, and then, will be conveyed to the transfer position in a state sucked by the conveying belt 53.

Then, the toner images on the photoconductor drums 31 of the respective image forming units 22 are successively superposed on the sheet of paper 24 by means of the transfer roll 50. The toner images having unfixed color components on the sheet 24 have been fixed by means of the fixing device 64, and thereafter, the sheet 24 having the fixed image will be discharged to the containing tray 67.

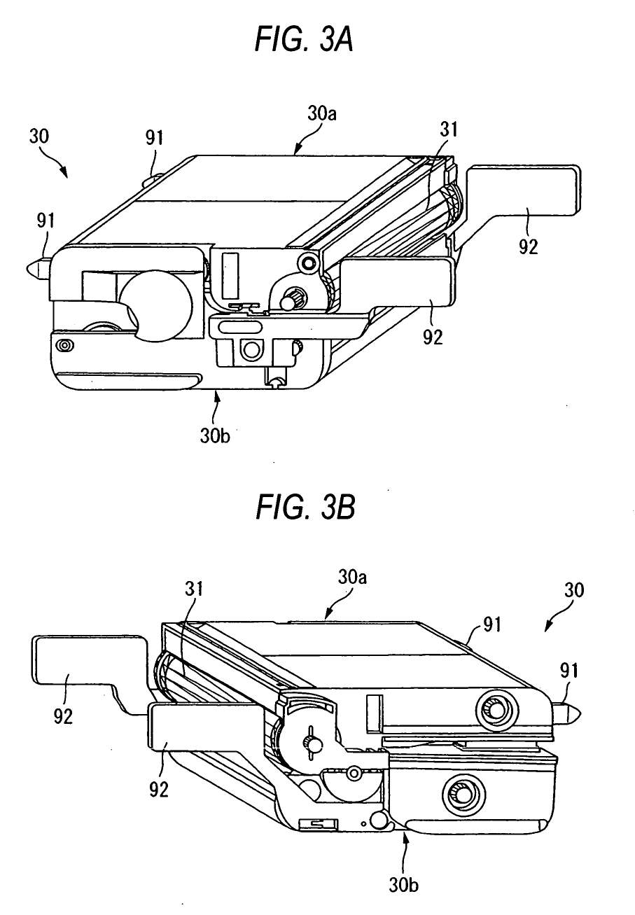

The process cartridge 30 in this embodiment includes, as shown in FIGS. 3A and 3B, a photoconductor cartridge 30a provided in an upper part and containing the photoconductor drum 31 and the cleaning device 34 (See FIG. 2), and a developing cartridge 30b provided in a lower part and containing the developing device 33 (See FIG. 2), which are integrally formed.

The process cartridge 30 is provided with a pair of support projections 91 which extend in a direction perpendicular to an axial direction of the photoconductor drum 31, at an opposite side to the photoconductor drum 31 of the process cartridge 30. When the process cartridge 30 is mounted on a cartridge receiving part (not shown) of the casing 21 of the apparatus, both ends of a support shaft of the photoconductor drum 31 are fixed at determined positions by means of fixture receiving members (not shown) provided on the cartridge receiving part, and at the same time, a drive transmitting member (a drive transmitting gear) provided at one end of the photoconductor drum 31 so as to be rotated with respect to the aforesaid support shaft is adapted to be connected and engaged with a driving system (not shown) which is provided in the cartridge receiving part. On this occasion, the aforesaid pair of the support projections 91 are adapted to be engaged with engaged parts (recesses or holes) of the cartridge receiving part, thereby to position the photoconductor cartridge 30a in the casing 21 of the apparatus. In this case, it would be sufficient that the cartridge receiving part of the casing 21 of the apparatus can contain and hold the process cartridge 30, and may be formed by using a frame of the casing itself, or may be formed by providing a separate member on the frame of the casing.

On the other hand, a pair of handle arms 92 are provided at a side of the photoconductor drum 31, for the purpose of securing attaching and detaching workability of the process cartridge 30 to and from the casing 21.

For information, FIG. 3A is a perspective view of the process cartridge 30 in FIG. 2, as seen from a substantially front side, and FIG. 3B is a perspective view, as seen from an opposite side.

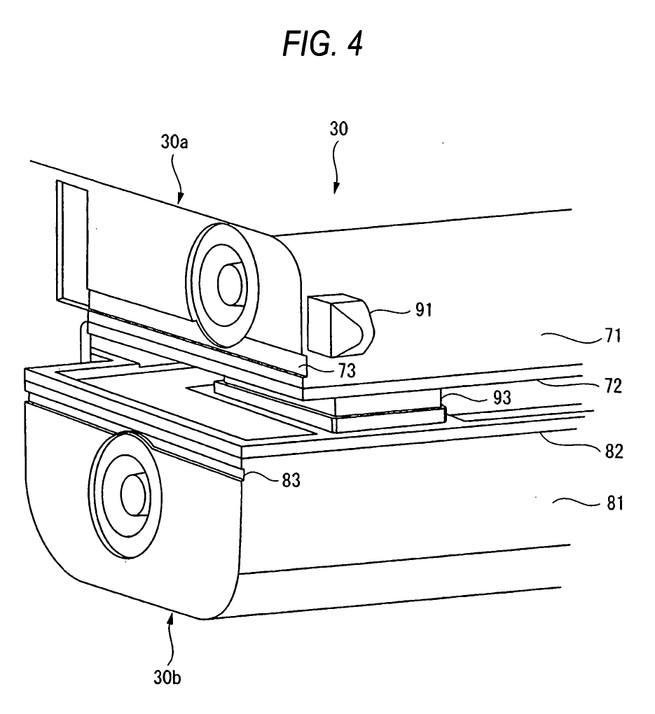

FIG. 4 shows a part of the process cartridge 30, as seen from the side of the support projection 91 in FIG. 3B. The photoconductor cartridge 30a includes an upper case 71 in a shape of a container which can contain various components inside, and a bottom case 72 which is provided as a lid for this upper case. Meanwhile, the developing cartridge 30b includes a lower case 81 in a shape of a container and a top case 82 which is provided as a lid for this lower case 81.

The upper case 71 and the lower case 81 are provided, at their respective one sides, with recesses 73 and 83 as engaged parts with which receiving jigs according to the invention can be engaged.

In this embodiment, all of the upper case 71, the bottom case 72, the lower case 81, and the top case 82 are formed of ABS resin of thermoplastic resin. Denoted by numeral 93 in the drawing is a spacer formed of elastic material which is provided between the photoconductor cartridge 30a and the developing cartridge 30b, for the purpose of pressing and urging the developing cartridge 30b toward the photoconductor cartridge 30a. In this embodiment, the toner contained in the photoconductor cartridge 30a is adapted to be guided to the developing cartridge 30b, by way of this spacer 93.

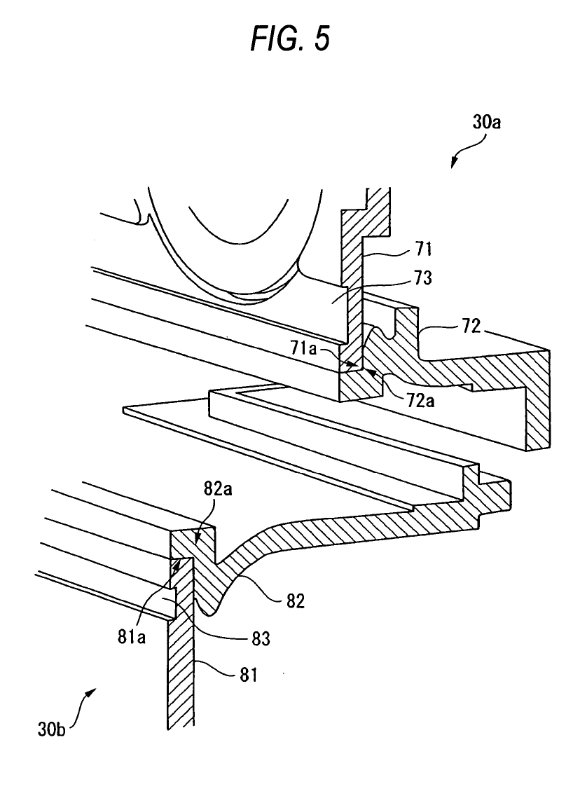

FIG. 5 is an enlarged perspective view of FIG. 4 partly shown in section. The upper case 71 and the bottom case 72 of the photoconductor cartridge 30a is welded by ultrasonic wave in a state where an end part 71a of the upper case 71 is engaged with a receiving part 72a of the bottom case a 72. Meanwhile, the lower case 81 and the top case 82 of the developing cartridge 30b is also welded by ultrasonic wave, in the same manner, in a state where an end part 81a of the lower case 81 is engaged with a receiving part 82a of the top case 82.

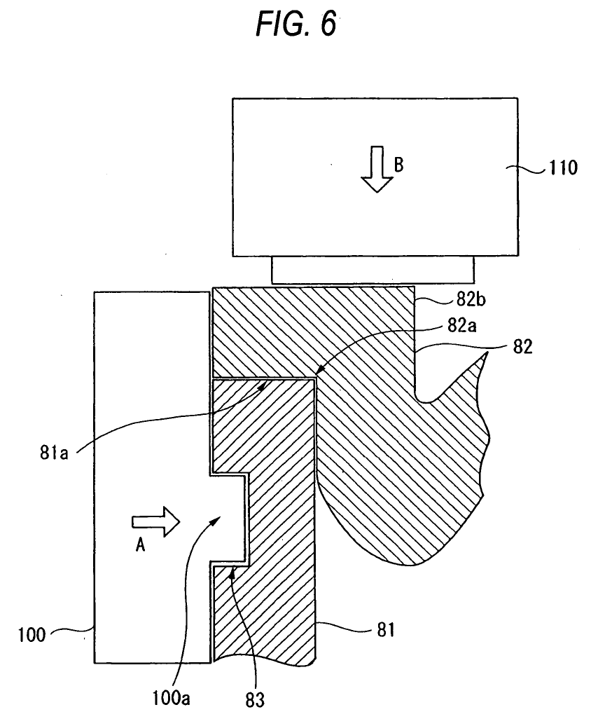

In this embodiment, the joint method by ultrasonic welding as described above will be conducted, as shown in FIG. 6. FIG. 6 shows a welding process between the lower case 81 and the top case 82. The lower case 81 is mounted on and held by a mold case which is not shown, and the receiving part 82a of the top case 82 is positioned on the end part 81a of the lower case 81. Thereafter, a projected portion 100a of a receiving jig 100 for welding is engaged with the recess 83 of the lower case 81. In the meantime, a welding horn 110 for ultrasonic welding abuts against an outer face of a top part 82b of the top case 82.

Then, the receiving jig 100 and the welding horn 110 are pressed in directions intersecting substantially at a right angle (pressed in a direction of arrow marks A and B in the drawing), and surfaces of the resins of both the end part 81a of the lower case 81 and the receiving part 82a of the top case 82 will be melted by friction heat which has been generated by ultrasonic energy from the welding horn 110, and fixed.

Although both the lower case 81 and the top case 82 are formed of ABS resin of thermoplastic resin in this embodiment, the material to be employed is not limited to this resin, but may be other resin, provided that ultrasonic welding can be performed. Moreover, although the welding horn 110 directly abuts against the top case 82 in this embodiment, it is possible to employ a separate abutting jig, and to abut the welding horn 110 interposing this abutting jig.

In this embodiment, the recess 83 of the lower case 81 is formed near the end part 81a, and a depth of the recess 83 is within a wall thickness of the lower case 81. Accordingly, a distance between the receiving jig 100 and the welding horn 110 at a time of welding can be made shorter, thereby enabling the lower case 81 and the top case 82 to be joined by rigid and stable welding as by so-called direct welding. In addition, an unnecessary protuberance such as a flange will be eliminated, and joint by welding capable of downsizing the apparatus can be attained.

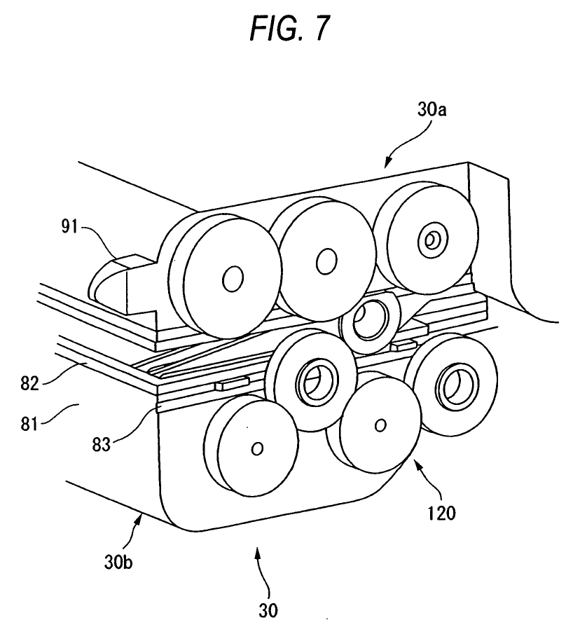

Then, welding joint system in other parts of the process cartridge 30 in this embodiment will be described. FIG. 7 is a perspective view of the process cartridge 30 in FIG. 3A, as seen from the side of the support projections 91, in which a surface cover of the process cartridge 30 is removed to show a gear train 120.

In order to constitute such gear train 120, it is necessary to provide a boss for containing the gear train 120, for example, on a same plane where the recess 83 is provided in the lower case 81. Therefore, in order to weld the lower case 81 to the top case 82 in such a case, the process described referring to FIG. 6 cannot be adopted, but a welding process (joint process by welding) taking projection of the boss into consideration will be adopted.

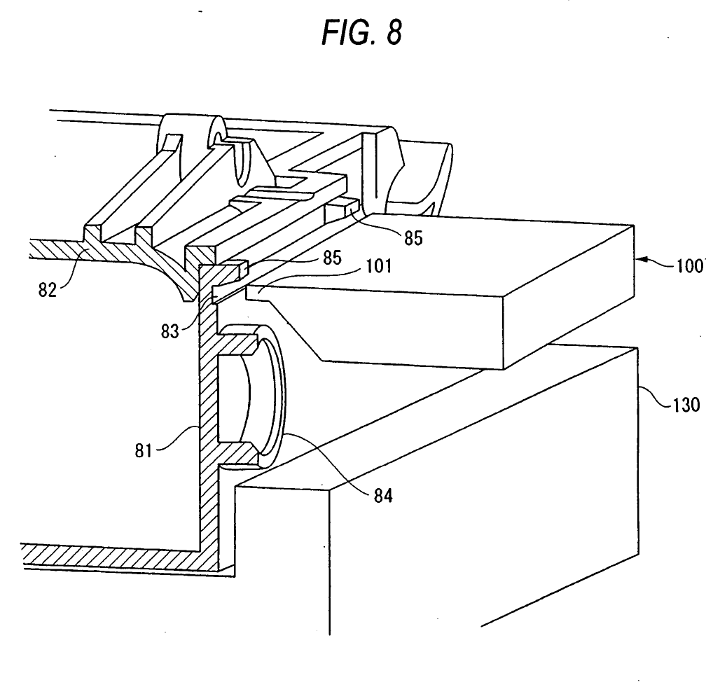

FIG. 8 shows the welding process in such a case, and the lower case 81 is provided with a boss 84 projected from an outer face, for making provision of the gear (not shown) possible. Accordingly, the recess 83 of the lower case 81 is remarkably dented from a projected face of the boss 84, and it will be difficult to directly abut the receiving jig 100 against the outer face of the lower case 81 at the time of welding. Therefore, the receiving jig 100 having a different shape from the shape as shown in FIG. 6 will be used. In this case, the receiving jig 100 has such a shape that when a tip end 101 of the receiving jig 100 is inserted into the recess 83, other portions of the receiving jig 100 may not come into contact with the boss 84 of the lower case 81.

Further, in this embodiment, the lower case 81 is provided with guide projections 85 projecting from the outer face, at two positions above the recess 83, in order to easily fit the tip end 101 of the receiving jig 100 into the recess 83 of the lower case 81. These guide projections 85 will serve as guides when the tip end 101 of the receiving jig 100 is inserted into the lower case 81. Because the receiving jig 100 will be inserted into the recess 83 while it slides along lower faces of the guide projections 85, the receiving jig 100 will be reliably fitted, and damage of the outer face of the lower case 81 caused by, for example, an attack of the tip end 101 of the receiving jig 100 will be eliminated. Denoted by numeral 130 in FIG. 8 is a mold case on which the lower case 81 is mounted and held.

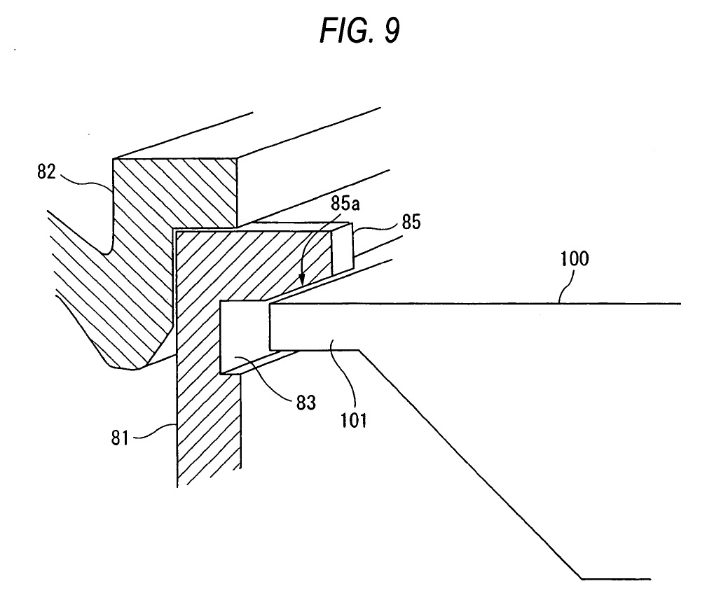

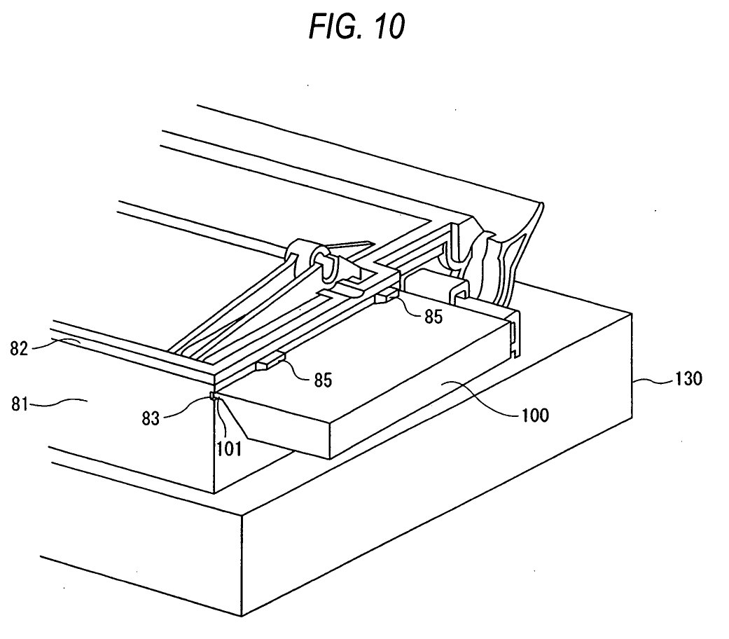

FIG. 9 shows the receiving jig 100 while it is inserted (fitted) into the recess 83 of the lower case 81. In this state, the tip end 101 of the receiving jig 100 is guided along the lower face 85a of the guide projection 85 to be fitted into the recess 83 of the lower case 81. FIG. 10 shows a state wherein the tip end 101 of the receiving jig 100 has been inserted into the recess 83 of the lower case 81.

In this manner, the receiving jig 100 is inserted into the recess 83 of the lower case 81, and then, a welding horn (not shown) abuts against the upper part of the top case 82 above the joined part (the welded part), so that ultrasonic welding can be performed between the receiving jig 100 and the welding horn.

As described above, in this embodiment, the upper case 71 and the lower case 81 are respectively provided with the recesses 73 and 83, and the receiving jig 100 at the time of ultrasonic welding is fitted into the recesses 73 and 83 so that the upper case and the lower case may be pressed between the receiving jig 100 and the welding horn 110 in the directions intersecting at the substantially right angle. Accordingly; the distance from the receiving jig 100 to the welding horn 110 can be made shorter, and rigid welding in the welded part can be performed. Therefore, it has become possible to realize the process cartridge 30 having high sealing performance. Moreover, because occurrence of a flange by welding can be eliminated, it is possible to downsize the process cartridge 30 in its entirety, and to enhance flexibility of layout.

Further, in this embodiment, in the welded part between the upper case 71 and the bottom case 72, and in the welded part between the lower case 81 and the top case 82, for example, the end part and the receiving part intersecting at the right angle are joined to each other. However, the joint can be also conducted by providing an inclined face in a part.

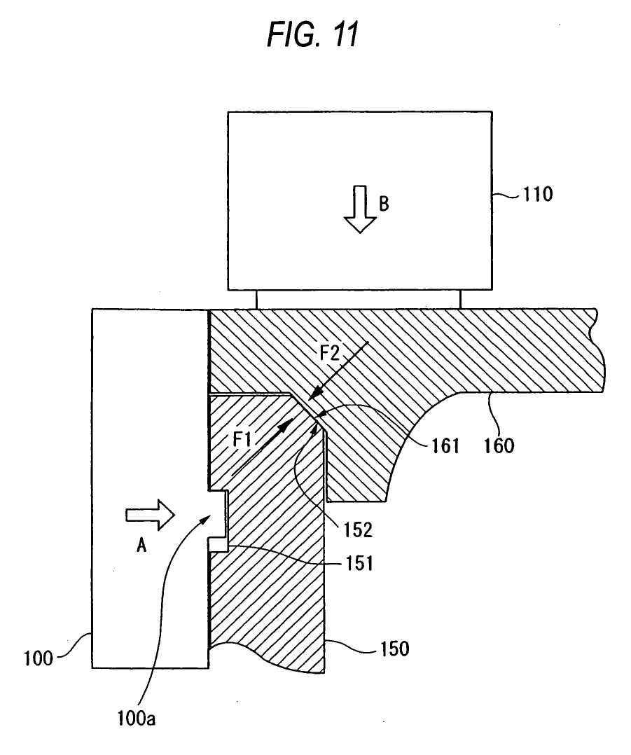

FIG. 11 is a schematic view showing a case of providing the inclined face. For example, a lower case 150 having a recess 151 which the receiving jig 100 for welding is engaged with, is fitted to a receiving part (an inclined face is formed in a part thereof) 161 of an upper case 160. On this occasion, a welded part between the lower case 150 and the upper case 160 is so constructed that their inclined faces 152 and 161 may come into contact with each other.

In such a shape, while a projected portion 100a of the receiving jig 100 for welding is inserted into the recess 151 of the lower case 150, the welding horn 110 abuts against an outer face of the upper case 160. In this case, the receiving jig 100 and the welding horn 110 press each other in directions intersecting at the substantially right angle (directions of arrow marks A and B in the drawing), and component forces of the pressure will be effectively applied to the respective inclined faces 152 and 161 corresponding to the welded part between the lower case 150 and the uppercase 160. Specifically, the component forces F1, F2 substantially perpendicular to the inclined faces 152 and 161 will be applied to the inclined faces 152 and 161. For this reason, the pressure will be concentrated into this very small area, whereby the joint between the lower case 150 and the upper case 160 by welding will be more rigidly conducted.

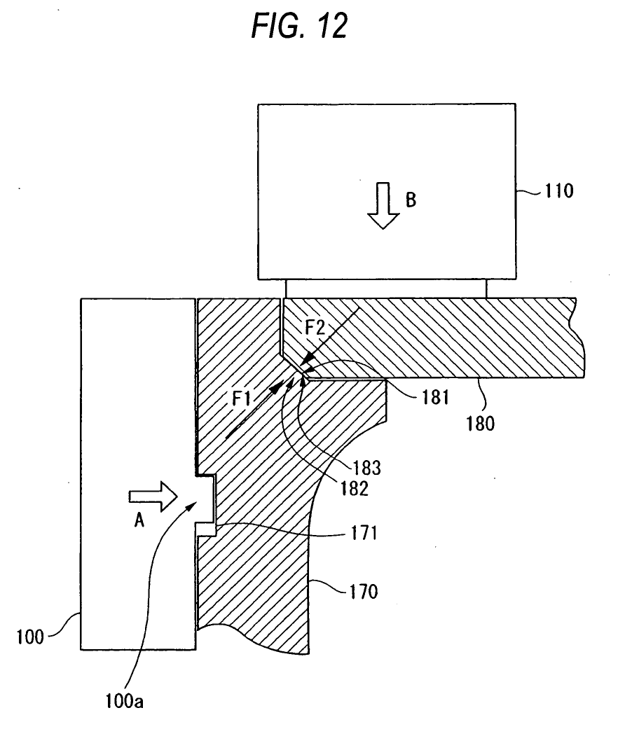

FIG. 12 shows a variation of the structure as shown in FIG. 11. In a structure in FIG. 12, a lower case 170 is provided with a recess 171 with which a projected portion 100a of the receiving jig 100 is engaged, and a receiving part 182 into which the upper case 180 is fitted. Moreover, the receiving part 182 is provided with an inclined face 183 in a part, which is adapted to come into contact with an inclined face 181 of the upper case 180.

In this structure too, pressure will be effectively exerted on the inclined faces 181 and 183 by the pressure of the receiving jig 100 and the welding horn 110 at the time of welding, in the same manner as in FIG. 11, and the joint between the lower case 170 and the upper case 180 by welding will be rigidly conducted.

Although an example of the ultrasonic welding process has been described as the welding process in this embodiment, other heat welding processes such as vibration welding process can be also employed, and it is apparent that substantially same effects as by the ultrasonic welding process can be attained.

Moreover, it is possible to provide small projections on at least a part of the surface of the welded part so that the small projections may be melted by preference thereby to perform the welding more easily.

Further, it is possible to provide an inclined face in only one of the welded parts so that an edge of a mating member may be melted by preference.

### Embodiment 2

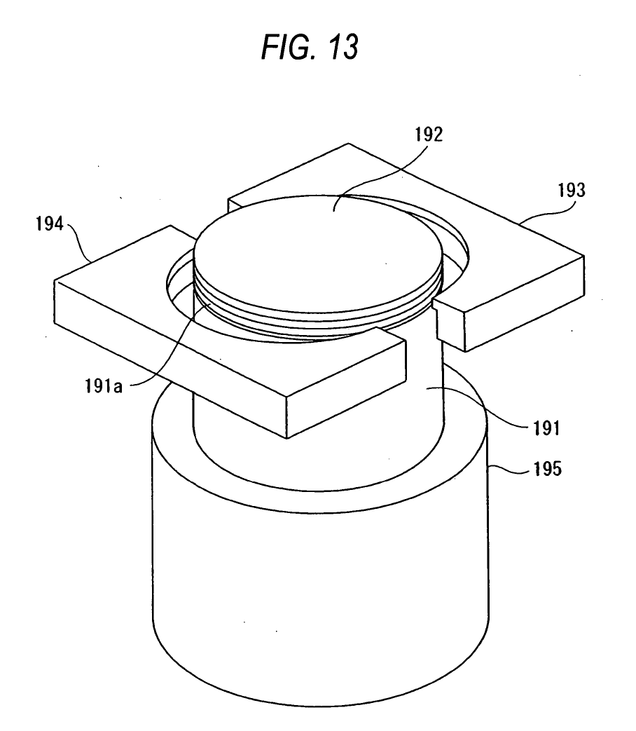

FIG. 13 shows an embodiment 2 in which the welding system according to the invention is employed. In the embodiment of FIG. 13, a cover 192 is welded to a container 191 in a cylindrical shape such as a toner cartridge.

In FIG. 13, the cover 192 is welded to an opening of the cylindrical container 191. In a state where the cover 192 is put on the cylindrical container 191, two divided receiving jigs 193 and 194 for welding are fitted into a recess 191a which is formed on an outer peripheral face of the cylindrical container 194, from directions opposed to each other. Denoted by numeral 195 in the drawing is a mold case for holding the cylindrical container 191 at the time of welding.

When the cylindrical container 191 and the cover 192 are welded, the receiving jigs 193 and 194 in this embodiment will clamp the cylindrical container 191, and the tip ends of the receiving jigs 193 and 194 will be inserted into the recess 191a of the cylindrical container 191.

Then, the welding horn which is not shown will abut against a surface of the cover 192 thereby to conduct welding.

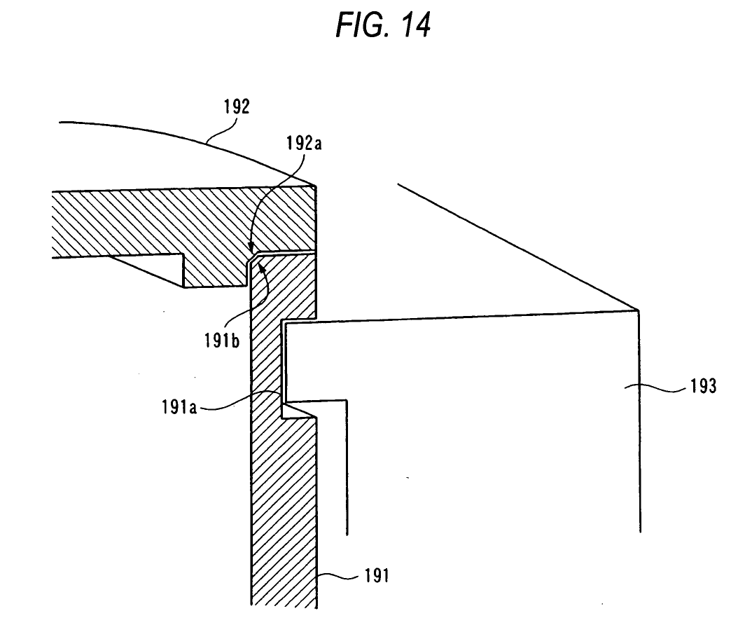

FIG. 14 is a sectional view showing a manner of welding in this embodiment. An end 191b of the cylindrical container 191 is engaged with a receiving part 192a of the cover 192. Further, the receiving part 192a and the end 191b are provided with inclined faces, whereby joint by welding between the cylindrical container 191 and the cover 192 can be rigidly performed.

In this manner, the rigid joint system by welding can be attained in this embodiment too.

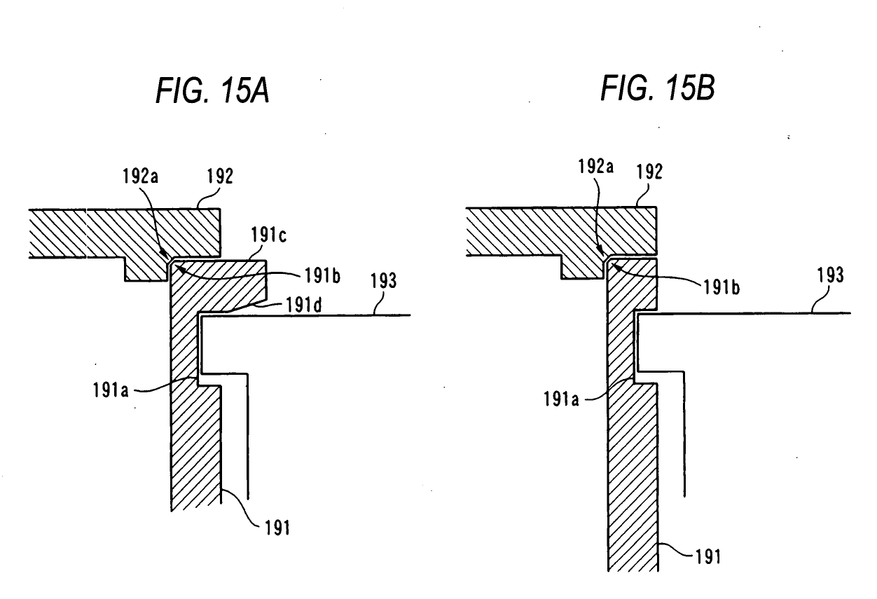

FIGS. 15A and 15B show variations of the embodiment 2. FIG. 15A shows a guide projection 191c for guiding the receiving jig 193 which is partly provided above the recess 191a of the cylindrical container 191. Being constructed in this manner, when the receiving jig 193 is inserted, the receiving jig 193 will slide along a lower face 191d of the guide projection 191c so that the receiving jig 193 can be easily inserted into the recess 191a. Accordingly, the receiving jig 193 will not strike an area around the recess 191a, thus preventing damage of the cylindrical container 191.

FIG. 15B shows a case where the guide projection is not provided, as in this embodiment. In such cases, it is needless to say that attention must be paid when the receiving jig 193 is inserted into the recess 191a.

According to the embodiment of the invention, material for the joining member and the joined member is not particularly limited, provided that the material can be welded by heat welding process. However, from a viewpoint of being easily applied to such welding process, thermoplastic resin is usually selected.

Moreover, because the receiving jig is received by the engaged part, a distance between the welding jig and the receiving jig at welding can be made smaller. Consequently, welding rigidity between the joining member and the joined member can be enhanced, and at the same time, joint in the welded part can be reliably performed. Further, it will be possible to prevent occurrence of the flanges during welding, which will be advantageous in downsizing the apparatus. A shape of the engaged part is not particularly limited as to whether or not it protrudes from the joining member or the joined member, provided that the receiving jig can be fitted in the engaged part.

The heat welding process in the embodiment of the invention is not particularly limited, provided that the welded part can be heated by energy from outside to be welded by heat. As the representative processes, there are ultrasonic welding process and vibration welding process. Moreover, other heat welding process can be also applied, provided that the receiving jig is engaged with the engaged part of the joining member, and the welding jig abuts against the outer face of the other member, at the position where the welded part is clamped between the engaged part and the other member. For example, high-frequency induction heating process in which high frequencies are applied to activate motion of molecules by varying polarity thereby to heat, electromagnetic induction heating process in which a metallic body (wire or the like) is incorporated in the welded part, and induction heating is conducted by electromagnetic waves from outside, or laser transmission welding process in which light transmitting material and light absorbing material are combined, and laser is irradiated from the light transmitting material, can be also applied.

Moreover, according to the embodiment of the invention, the engaged part is preferably provided in either of the joining member and the joined member in vicinity of the welded part, and formed as a recess which is dented from the outer face of the joining member or the joined member. By forming the engaged part as the recess in this manner, it is possible to eliminate unnecessary projected portions such as flanges at the time of welding. When this is applied to a container, for example, it would be possible to realize a downsized container.

Further, the engaged part is preferably provided with a guide projection for guiding the receiving jig into the recess, in a part of a surrounding edge of the recess. This will make the receiving jig to be easily fitted into the recess, when the receiving jig is set, and will prevent the receiving jig from striking a corner of the recess, when fitted therein, thereby to prevent the member from being broken. Further, in case where this guide projection is provided in a part of an upper edge of the recess, welding can be performed as it is, more preferably, because engaged state of the welded part will not be influenced, when the receiving jig is fitted into the recess.

Still further, according to the embodiment of the invention, the end face of the joining member and the joint receiving part of the joined member preferably have inclined faces respectively, in at least a part thereof. By providing the inclined faces in the welded part, pressures of the receiving jig and the welding jig will effectively reach the inclined faces in mutual directions, and the joint between the joining member and the joined member will be more rigidly performed. As the welding jig, a so-called welding horn may directly abut against the outer face of the joining member or the joined member Alternatively, a separate jig member can indirectly abut.

According to the embodiment of the invention, it is possible to realize a powder treating device employing a powder container which has been joined by the above described jointed assembly. In this case, by using developing agent as the powder, it is possible to downsize a developing agent cartridge, a process cartridge, a waste toner box, and a developing device which are used in an image forming apparatus of a type in which a latent image is visualized employing powder developing agent according to electro-photographic system or the like. Moreover, by using such developing agent cartridge, process cartridge, waste toner box, and developing device, it will be possible to realize a compact image forming apparatus. In this case, the developing agent means both the developing agent of toner only, and the developing agent containing toner and carrier.

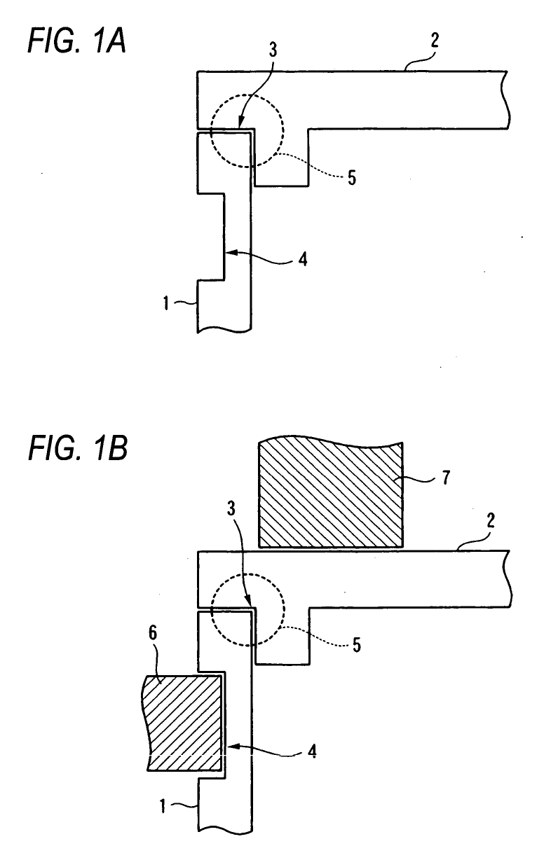

Still further, as shown in FIG. 1B, the receiving jig is fitted in the engaged part which is provided in either one of the joining member and the joined member, and the welding jig abuts against the outer face of the other member, whereby the joining member 1 and the joined member are joined together by heat welding process.

On this occasion, the receiving jig and the welding jig preferably press each other in directions intersecting at a substantially right angle. In this case, the receiving jig and the welding can be arranged close to each other, and at the same time, the joint between the joining member and the joined member can be more stably performed. Although positional displacement of the welded part will not happen when the members are pressed by each other, it is needless to say that the pressure of such extent that the engaged part may not be deformed will be applied.

Still further, an assembling jig including the receiving jig which is fitted into the engaged part in either one of the joining member and the joined member, and the welding jig which is pressed onto the outer face of the other member, and the receiving jig may have a projected portion which can be fitted into the engaged part. In this manner, by engaging a tip end (the projected portion) of the receiving jig 6 with the engaged part, it is possible to deal with the jointed assembly of a small size.

According to the embodiment of the invention, in case where the joining member and the joined member are joined by the ultrasonic welding process or the vibration welding process, the engaged part to be engaged with the receiving jig at welding is provided on the outer face of either one of the joining member and the joined member. Therefore, an unnecessary protuberance such as a flange will be eliminated, and it is possible to realize the jointed assembly which can be downsized and provided with stable joint.

Moreover, by employing the powder container which has been joined by this jointed assembly, it is possible to provide the downsized powder treating device. Further, by applying the powder to the developing agent, it is possible to provide the downsized developing agent cartridge, process cartridge, waste toner box, developing device, and image forming apparatus.

Still further, it is also possible to provide the method of assembling the above described jointed assembly, and the assembling jig.

The entire disclosure of Japanese Patent Application No. 2005-244008 filed on Aug. 25, 2005 including specification, claims, drawings and abstract is incorporated herein be reference in its entirety.

What is claimed is:

1. A jointed assembly comprising:
a first joining member having a face to be welded at at least an end face thereof; and
a second joining member having a joint receiving part to which the end face of the first joining member is joined;
wherein one of the first and second joining members includes on an outer face thereof an engaged part with which a receiving jig is engaged when the first and second joining members are welded to each other by a heat welding process;
wherein the other of the first and second joining members includes on an outer face thereof an abutting part against which a welding jig abuts; and
wherein a welded part at which the first and second joining member are welded is interposed between the abutting part and the engaged part.

2. The jointed assembly according to claim 1,
wherein the engaged part is provided with the one of the first or the second joining members in vicinity of the welded part; and
wherein the engaged part is formed with a recess which is dented from the outer face of the one of the first and second joining members.

3. The jointed assembly according to claim 2,
wherein the engaged part includes a guide projection that guides the receiving jig into the recess in apart of a surrounding edge of the recess.

4. The jointed assembly according to claim 1,
wherein the end face of the first joining member and the joint receiving part of the second joining member include inclined faces respectively in at least a part thereof.

5. A powder treating device comprising:
a powder container including the jointed assembly of claim 1.

6. The powder treating device according to claim 5,
wherein the powder includes a developing powder.

7. An assembling method for assembling a jointed assembly of claim 1, the method comprising:
fitting the receiving jig in the engaged part which is provided in the one of the first and second joining members; and
joining the first and second joining members;
wherein, in the joining, the welding jig abuts against the abutting part of the other of the first and second joining members.

8. The assembling method for the jointed assembly of claim 7,
wherein the receiving jig and the welding jig press each other in directions intersecting at a substantially right angle.

9. An assembling jig for assembling the jointed assembly of claim 1, the jig comprising:
the receiving jig which is fitted into the engaged part in the one of the first and second members; and
the welding jig which is pressed onto the outer face of the other of the first and second joining members;
wherein the receiving jig includes a projected portion to be fitted into the engaged part.
